(19) United States
(12) Patent Application Publication
(10) Pub. No.: US 2022/0318760 A1
(43) Pub. Date: Oct. 6, 2022

(54) UPDATING PARTICIPANTS ON MEETING INVITES ACROSS CALENDAR SYSTEMS

(71) Applicant: Avaya Management L.P., Durham, NC (US)

(72) Inventors: Isha Renavikar, Pune (IN); Shahana Mogal, Pune (IN); Ananda H P, Pune (IN)

(21) Appl. No.: 17/219,362

(22) Filed: Mar. 31, 2021

(51) Int. Cl. G06Q 10/10

(52) U.S. Cl. CPC G06Q 10/1095

(57) ABSTRACT

The technology disclosed herein enables meeting participants on a meeting invite to be updated across calendar systems. In a particular embodiment, a method includes, in a first calendar system, receiving a notification that a meeting invite for a meeting between a first participant and a second participant is forwarded to a third participant. The first calendar system maintains a first copy of the meeting invite on behalf of the first participant and a second calendar system maintains a second copy of the meeting invite on behalf of the second participant. In response to the notification, the method provides updating the first copy to include the third participant and directing the second calendar system to update the second copy to include the third participant.

### TECHNICAL BACKGROUND

Electronic calendar systems maintain calendar entries on behalf of users thereof. A user may access their calendar on a calendar system through a web-browser interface (e.g., web app) to the calendar system or through a user interface of an application specifically designed to allow access to the electronic calendar (e.g., a dedicated calendar app, a combination email, calendar, and/or contacts list app, or some other type of app with a calendar interface). Many modern calendar system allow a user to share a calendar entry with other users so that the calendar entry appears in the electronic calendars of those users without the other users having to manually enter their own corresponding calendar entry. Especially in cases where a user is receiving a shared calendar entry on a different calendar system from which the shared calendar entry originated, updates to the shared calendar entry in the user's calendar may not propagate.

### SUMMARY

The technology disclosed herein enables meeting participants on a meeting invite to be updated across calendar systems. In a particular embodiment, a method includes, in a first calendar system, receiving a notification that a meeting invite for a meeting between a first participant and a second participant is forwarded to a third participant. The first calendar system maintains a first copy of the meeting invite on behalf of the first participant and a second calendar system maintains a second copy of the meeting invite on behalf of the second participant. In response to the notification, the method provides updating the first copy to include the third participant and directing the second calendar system to update the second copy to include the third participant.

In some embodiments, directing the second calendar system to update the second copy includes sending an update message to the second calendar system, wherein the update message identifies the meeting invite and the third participant.

In some embodiments, directing the second calendar system to update the second copy includes sending an updated version of the meeting invite to a user system of the second participant, wherein the updated version includes third participant and wherein the user system updates the second calendar system.

In some embodiments, directing the second calendar system to update the second copy includes directing the second calendar system to include an email address of the third participant on the second copy of the meeting invite with email addresses of the first and second participants.

In some embodiments, updating the first copy comprises including an email address of the third participant with email addresses of the first and second participants on the first copy.

In some embodiments, the notification comprises a forwarding notification indicating that the meeting invite has been emailed from the first participant to the third participant.

In some embodiments, the notification comprises an instruction from the first participant to include the third participant on the meeting invite.

In some embodiments, before receiving the notification, the first calendar system maintains another copy of the meeting invite on behalf of a fourth participant on the meeting and the method includes, in response to the notification, updating the other copy to include the third participant.

In some embodiments, after the second copy is updated, further updates to the second copy by the second participant are propagated to the first participant and the third participant.

In another embodiment, an apparatus is provided having one or more computer readable storage media and a processing system operatively coupled with the one or more computer readable storage media. Program instructions stored on the one or more computer readable storage media, when read and executed by the processing system, direct the processing system to receive a notification that a meeting invite for a meeting between a first participant and a second participant is forwarded to a third participant. A first calendar system implemented by the processing system maintains a first copy of the meeting invite on behalf of the first participant and a second calendar system maintains a second copy of the meeting invite on behalf of the second participant. In response to the notification, the program instructions direct the processing system to update the first copy to include the third participant and direct the second calendar system to update the second copy to include the third participant.

### BRIEF DESCRIPTION OF THE DRAWINGS

FIG. 1 illustrates an implementation for updating participants on a meeting invite across calendar systems.

FIG. 2 illustrates an operation to update participants on a meeting invite across calendar systems.

FIG. 3 illustrates another implementation for updating participants on a meeting invite across calendar systems.

FIG. 4 illustrates an operational scenario for updating participants on a meeting invite across calendar systems.

FIG. 5 illustrates a further operational scenario for updating participants on a meeting invite across calendar systems.

FIG. 6 illustrates yet another operational scenario for updating participants on a meeting invite across calendar systems.

FIG. 7 illustrates a computing architecture for updating participants on a meeting invite across calendar systems.

### DETAILED DESCRIPTION

A shared calendar entry is commonly called a meeting invite, even in situations where the calendar entry is for an event other than a meeting (e.g., a party). Therefore, the shared calendar entries are referred to as meeting invites below, although other names for shared calendar entries may exist. The examples provided herein enable updating of participants on a meeting invite that is stored as an entry in multiple calendar systems. In general, when a meeting invite is forwarded to a new participant, the meeting organizer (i.e., the user that created the meeting invite) is notified of the forwarding. From that notification, the copy of the meeting invite that is stored in the organizer's electronic calendar on a calendar system can be updated. Rather than leaving the copies of the meeting invite stored as entries on other calendar systems as is (i.e., listing the same participants as before the meeting invite was forwarded), the calendar system herein directs the other calendar systems to update their copies to include the new participant to which the meeting invite was forwarded.

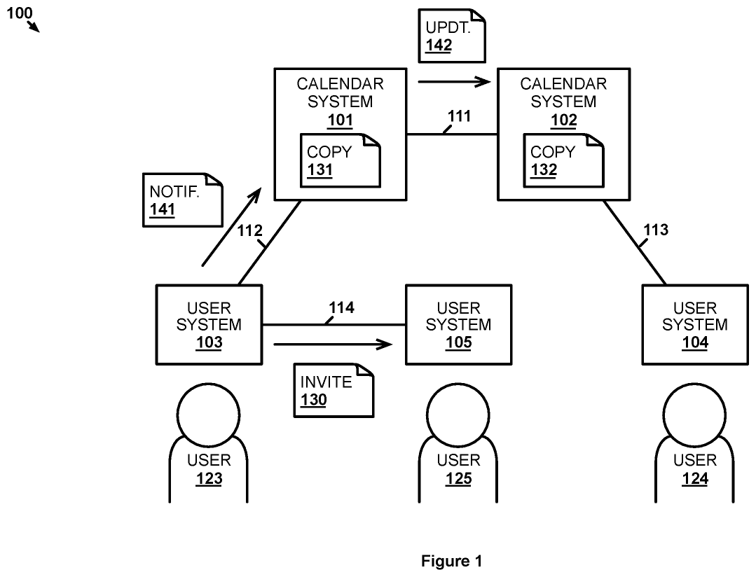

FIG. 1 illustrates implementation 100 for updating participants on a meeting invite across calendar systems. Implementation 100 includes calendar system 101, calendar system 102, user system 103, user system 104, and user system 105. Calendar system 101 and calendar system 102 communicate over communication link 111. Calendar system 101 and user system 103 communicate over communication link 112. Calendar system 102 and user system 104 communicate over communication link 113. User system 103 and user system 105 communicate over communication link 114. Communication links 111-114 are shown as direct links but may include intervening systems, networks, and/or devices.

In operation, calendar system 101 is a computing system (e.g., server or collection of servers) that maintains calendar events in an electronic calendar for user 123 and calendar system 102 is a computing system maintains an electronic calendar for user 124. User systems 103-105 may each respectively be a telephone, tablet computer, laptop computer, desktop computer, conference room system, or some other type of computing device capable of accessing a calendar system. User 123 operates user system 103 to access their electronic calendar on calendar system 101 and user 124 operates user system 104 to access their electronic calendar on calendar system 102. User system 103 and/or user system 104 may execute a software application that includes a user interface that natively presents the calendars of user 123 and user 124 from calendar system 101 and calendar system 102, respectively. Alternatively, user system 103 and/or user system 104 may execute a web browser application that present a web-based interface to the calendars on calendar system 101 and calendar system 102, respectively. The web-based interface may be provided by a web server in calendar system 101 and/or calendar system 102, or may be provided by another system. Other manners of accessing electronic calendars via user systems may also be used. User 125 operates user system 105 to access their electronic calendar. User 125's calendar may be maintained locally by user system 105, may be maintained by calendar system 101 or calendar system 102, or may be maintained by some other calendar system. While only one user system is shown to be associated with each of users 123-125, one or more of users 123-125 may access their calendars from multiple user systems. For example, user 123 may access their calendar via both a laptop computer and a smartphone, either of which may be user system 103.

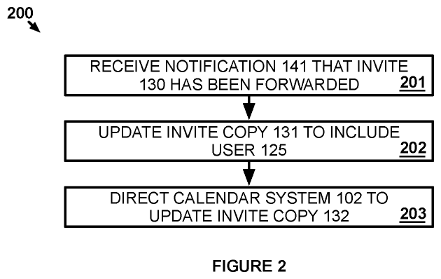

FIG. 2 illustrates operation 200 to update participants on a meeting invite across calendar systems. Before operation 200 occurs, a meeting has already been scheduled between user 123 and user 124 as participants, although, more than two participants may be included in other examples. The meeting may be a remote meeting (e.g., video conference) or may be an in-person meeting. Other meetings may include a combination of remote and in person participants. The meeting is represented in calendar system 101 and calendar system 102 as invite copy 131 and invite copy 132, respectively. Invite copy 131 and invite copy 132 at least identify the participants for the meeting, which are user 123 and user 124 in this case, but may also indicate information such as a title for the meeting, a day and time for the meeting, a duration for the meeting, bridge information (e.g., web address to connect to a video conference bridge), notes about the meeting (e.g., an agenda, a moderator message, etc.), documents related to the meeting (e.g., presentation slides), an invite acceptance status of each participant, and/or some other type of information relevant to a meeting that can be stored by a calendar system. While invite copy 131 and invite copy 132 are referred to as copies, either of invite copy 131 or invite copy 132 may be the originally created invite for the meeting. Similarly, while referred to as invites, invite copy 131 and invite copy 132 represent calendar entries for the meeting in the calendars of user 123 and user 124. For example, user 123 may have created invite copy 131 using user system 103 while designating user 124 as a participant (e.g., using an email address of user 124, a phone number of user 124, a username or handle of user 124, or some other manner of electronically addressing information to user 125), which caused invite copy 132 to be sent to user system 104. Upon acceptance of invite copy 132, invite copy 132 is entered into user 124's calendar in calendar system 102. Invite copy 132 may have the same formatting as invite copy 131 or, if calendar system 102 uses different conventions (e.g., is a calendar system from a different vendor), then invite copy 132 may use a different format.

In operation 200, calendar system 101 receives update notification 141 that invite copy 130 for the meeting between user 123 and user 124 has been forwarded to user 125 (201). In this example, invite copy 130 is transferred from user system 103 to user system 105 (e.g., via an email message) and user system 103 transfers update notification 141 to calendar system 101. In this example, update notification 141 indicates that user 125 has been added to the participant list by user 123. Like user 124 in the example above, user 125 may be identified in update notification 141 by email address, by phone number, by username/handle, or some other manner of electronically addressing information to user 125. In some cases, user 125 may be identified by their real name and calendar system 101 may be able to obtain addressing information from the real name (e.g., from a contact information entry for user 125). In some examples, update notification 141 may not be sent from user system 103 until after acceptance of invite copy 130 by user 125 is received at user system 103 from user system 105. In some examples, update notification 141 may be a request from user 123 to include user 125 in the meeting participants. In those situations, invite copy 130 may be transferred from calendar system 101 to user system 105 rather than from user system 103 directly.

In response to the notification, calendar system 101 updates invite copy 131 to include user 125 (202). After updating, user 125, including addressing information thereto (e.g., email address), is listed in invite copy 131 along with user 123 and user 124. If calendar system 101 maintained electronic calendars for other participants in the meeting, updating invite copy 131 may apply to those calendars as well (e.g., the same invite copy 131 may be used across calendars) or calendar system 101 may update the invite copies for those calendars.

Since calendar system 101 does not maintain the calendar for user 124, calendar system 101 directs calendar system 102 to update invite copy 132 to also include user 125 (203). In this example, calendar system 101 sends update message 142 to calendar system 102. Update message 142 indicates to calendar system 102 that user 125 has been added to the meeting participants of invite copy 132. Calendar system 101 may identify calendar system 102 as being associated with user 124 based on contact information for user 124, based on information included in a response from user 124 to the original meeting invite (e.g., user 124's invite acceptance may indicate that calendar system 102 is used for their calendar), or may be determined from some other source. In other examples, to direct calendar system 102 to update invite copy 132, calendar system 101 may instead transfer update message 142 to user system 104 as an updated invite copy 132 that includes user 125 in the list of participants. In those examples, user system 104 would then transfer the updated invite copy 132 to calendar system 102.

Advantageously, when user 123 adds user 125 to the participant list for the meeting, user 124 is also notified of the addition due to invite copy 132 also being updated. Otherwise, only copies the invite stored in calendar system 101 would receive the update, which leaves user 124 unaware of user 125's inclusion. Moreover, should user 124 want to send a message to, or otherwise contact, all participants listed on invite copy 132, operation 200 ensures that user 125 will receive the message along with user 123 due to also being listed as a participant.

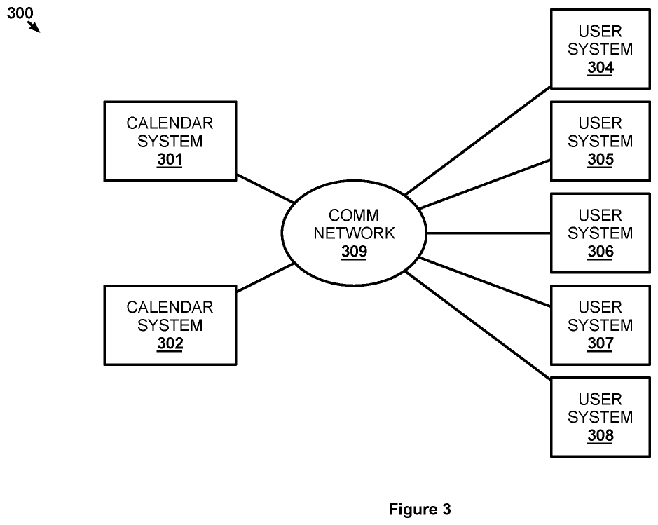

FIG. 3 illustrates implementation 300 for updating participants on a meeting invite across calendar systems. Implementation 300 includes calendar systems 301-302, user systems 304-308, and communication network 309. Communication network 309 includes one or more local area and/or wide area computing networks, including the Internet, over which computing systems communicate. User systems 304-308 may each comprise a telephone, laptop computer, desktop workstation, tablet computer, conference room system, or some other type of user operable computing device.

In operation, calendar system 301 maintains electronic calendars on behalf of the user of user system 304 and the user of user system 305. Similarly, calendar system 302 maintains electronic calendars on behalf of the user of user system 306 and the user of user system 307. One of calendar systems 301-302 may also maintain a calendar on behalf of the user of user system 308, although another calendar system, or user system 308 itself, may maintain the calendar instead. In some examples, depending on the capabilities of calendar systems 301-302 and/or user systems 304-308, one or more of user systems 304-308 may synchronize the electronic calendars of their respective users to store a local copy. For instance, user system 304 may access the electronic calendar of its user through a web browser interface that does not synchronize a local copy of the calendar, while user system 305 may access the electronic calendar of its user through a productivity application that synchronizes the calendar on calendar system 301 with a locally stored copy. Regardless of whether a local copy is synchronized, calendar entries may be created, updated, deleted, or otherwise modified using user systems 304-308 and those calendar entries are affected in the electronic calendars stored on respective calendar systems 301-302.

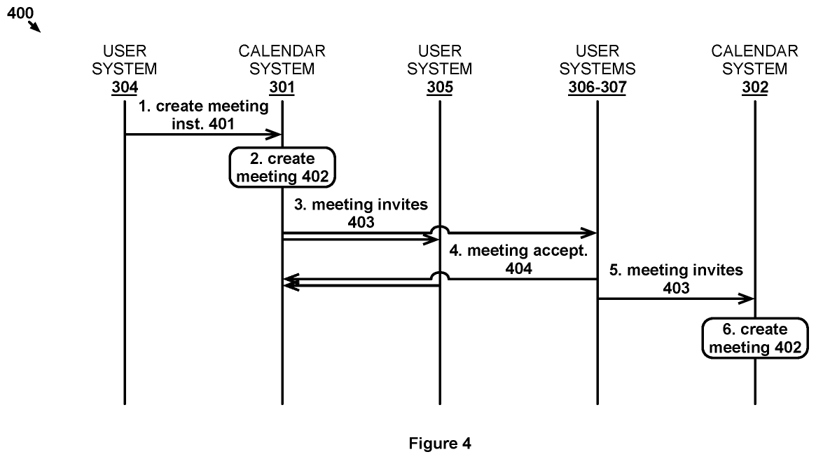

FIG. 4 illustrates operational scenario 400 for updating participants on a meeting invite across calendar systems. Operational scenario 400 is an example of how the user of user system 304 may create a meeting invite that initially includes themselves and the users of user systems 305-307 as participants. In this example, the meeting invites are transmitted over email and, therefore, the participants are each identified at least by their respective email addresses, although additional identification information, such as a participant's name, may also be included.

User system 304 transfers create-meeting instruction 401 to calendar system 301 at step 1. Create-meeting instruction 401 instructs calendar system 301 to create meeting 402 at step 2 based on meeting details defined in create-meeting instruction 401 by the user of user system 304 who is now the meeting organizer. Create-meeting instruction 401 is transferred in a protocols or conventions (e.g., communication format, encryption, command instructions, etc.) that is used for interactions with calendar services provided by calendar system 301, which may be the same as or different from the protocols or conventions used by calendar system 302. It should be understood that the interactions between user systems and calendar systems described below all occur using the appropriate protocols and conventions for the particular calendar system. The meeting details may include a start time, an end time/duration, a title, a description, associated documents, alert parameters (e.g., alert 10 minutes before start time), conference bridge information, or any other information that may be relevant to a meeting entry in a calendar. In this example, the meeting details further include a list of participants for meeting 402, which are the users of user system 304-307, as identified by their respective email addresses. Create-meeting instruction 401 may be transferred in response to the user of user system 304 instructing an application (e.g., web browser interface or natively executing calendar app) to create an entry for meeting 402 and providing the meeting details thereto. In some examples, create-meeting instruction 401 may be sent to calendar system 301 after all details have been entered (e.g., after the user selects a button to finalize the details) or create-meeting instruction 401 may be sent upon the user indicating that an entry for meeting 402 should be created with the details following in additional messages thereafter when entered.

In this example, calendar system 301 is associated with the email system for the user of user system 304 (e.g., may serve for calendar and email services to the organizer), which allows calendar system 301 to send emails on behalf of the meeting organizer (i.e., using the email organizer's email address). As such, calendar system 301 sends meeting invites 403 in emails to user systems 305-307 at step 3 on behalf of the meeting organizer. In other examples, calendar system 301 may send meeting invites 403 in emails from a different email address (e.g., if calendar system 301 is not associated with the organizer's email) or may instruct user system 304 to send meeting invites 403 itself. Upon receiving meeting invites 403, each of user systems 305-307 transfer meeting acceptances 404 back to calendar system 301 at step 4. Each of meeting acceptances 404 may be transferred in response to the respective users of user systems 305-307 indicating their acceptance (e.g., by selecting an acceptance button in a calendar or email application executing on user systems 305-307). Upon receiving each of meeting acceptances 404, calendar system 301 may update the entry for meeting 402 to indicate that the participants have accepted. In other examples, if a participant does not accept, then calendar system 301 may indicate that they have yet to accept or, if they have declined, calendar system 301 may indicate that the participant declined.

Since the calendar for the user of user system 305 is maintained by calendar system 301, the acceptance from user system 305 indicates that an entry for meeting 402 should be added to the user's calendar. Calendar system 301 may make a copy of the entry for meeting 402 for storing in the other user's calendar or the user calendar may simply show the copy of meeting 402 already created for the meeting organizer. After accepting meeting invites 403, user systems 306-307 forward their copies of meeting invites 403 to calendar system 302. Upon receiving meeting invites 403, calendar system 302 creates a calendar entry for meeting 402 at step 6 for the respective calendars of the users of user systems 306-307. Each calendar may include its own copy of the entry for meeting 402 or both calendars may present the same copy since calendar system 302 maintains both calendars.

In some examples, calendar system 302 may be associated with the email system for the users of user systems 306-307. In those examples, user systems 306-307 may not need to send meeting invites 403 to calendar system 302. Rather, calendar system 302 may identify meeting invites 403 from the users' respective email inboxes. Similarly, while meeting invites 403 are not sent to calendar system 302 until after meeting acceptances 404 are sent, calendar system 302 may create an entry for meeting 402 before meeting invites 403 are accepted. For instance, a placeholder entry may be created to show a user where in respect to their schedule meeting 402 will fit. Of course, other manners of creating meeting entries and inviting participants thereto may be used instead of that described in operational scenario 400.

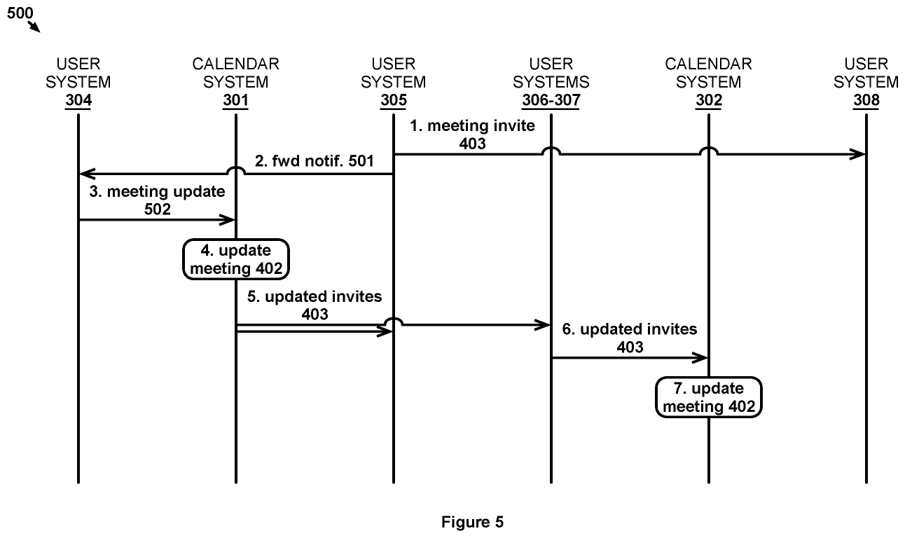

FIG. 5 illustrates operational scenario 500 for updating participants on a meeting invite across calendar systems. Operational scenario 500 occurs at a time after completion of operational scenario 400 where the users of user systems 304-307 all include entries for meeting 402 in their calendars on respective calendar systems 301-302 with those entries listing the users of user systems 304-307 as participants. Preferably, operational scenario 500 occurs before meeting 402 starts but may occur during a meeting so that a new participant can join. There may also be situations where someone should be added after a meeting has ended (e.g., so the participants can easily include the newly added user in further email discussions about meeting topics) or meeting 402 may be a recurring meeting (e.g., occurring every Tuesday) where a new participant is added for future instances of the recurring meeting.

Operational scenario 500 begins with the user of user system 305 directing user system 305 to forward meeting invite 403 to user system 308 at step 1. In this example, since user system 305 received meeting invite 403 in an email message, the user of user system 305 may direct an email client on user system 305 to forward the message having meeting invite 403 to an email address of the user of user system 308. Alternatively, the user may access their calendar through user system 305 to add the email address of the user of user system 308 to the details of the entry for meeting 402, which triggers calendar system 301 to send meeting invite 403 in an email to user system 308. Similarly, since the organizers calendar is also stored on calendar system 301, updating the entry from user system 305 may also trigger calendar system 301 to update the organizers calendar entry for meeting 402 as well. In those cases, forwarding notification 501 may be transferred from calendar system 301 to user system 304 or calendar system 301 may otherwise notify the organizer of the update.

In response to meeting invite 403 being forwarded, user system 305 also transfers forwarding notification 501 to user system 304 (i.e., to the email address of the organizer), at step 2, to inform the meeting organizer that meeting invite 403 has been forwarded to the email address of the user of user system 308, which indicates to user system 304 that the email address of the user of user system 308 should be added to the participant list on meeting 402. Instructions may be included in meeting invite 403 to direct user system 305 to send forwarding notification 501 when meeting invite 403 is forwarded or instructions may be included in an email or calendar application on user system 305 that direct user system 305 to send forwarding notification 501 when meeting invite 403 is forwarded. Upon receiving forwarding notification 501, user system 304 transfers meeting update message 502 to calendar system 301, at step 3, to inform calendar system 301 that the email address of the user of user system 308 should be included in the participant list of meeting 402 along with the four other participants of user systems 304-307. In some examples, user system 304 may add the email address to a local copy of meeting 402 and then meeting update message 502 is part of a synchronization of the local meeting copy with the copy stored on calendar system 301 for the organizer's calendar.

In response to receiving meeting update message 502, calendar system 301 updates the entry for meeting 402 in the calendar of the organizer at step 4. Rather, than stopping there with the organizer's calendar being updated, calendar system 301 transfers updated meeting invites 403 at step 5. Updated meeting invites 403 include the user of user system 308 in the list of participants in addition to the users of user systems 304-307. Calendar system 301 may already have a process for sending updated meeting invites when details of a meeting change (e.g., when the start time changes) and that same process may be used here to send updated meeting invites 403 (e.g., which change the participant list instead of the start time or other detail). In other examples, calendar system 301 may instruct user system 304 to send updated meeting invites 403 instead.

Upon receiving the updated meeting invites 403, user systems 306-307 each pass updated meeting invites 403 to calendar system 302 at step 6. In other examples, a calendar application on user systems 306-307 may instead notify calendar system 302 of the updates to meeting invite 403 using the protocols and conventions of calendar system 302. In an example, user systems 306-307 may each update local copies of the calendar entry for meeting 402 and calendar system 302 may be notified of the updates when those local copies are synchronized with copies on calendar system 302. Regardless, upon receiving updated meeting invites 403, or other indication thereof, calendar system 302 updates the entries for meeting 402 in the calendars of the users of user systems 306-307 at step 7 to include the user of user system 308. While not shown, user system 305 may also pass updated meeting invite 403, or otherwise update calendar system 301 about the updates to meeting invite 403. Although, in this example, since calendar system 301 also maintained the organizer's calendar, calendar system 301 automatically updated the entry in the calendar of the user of user system 305. In some such cases, calendar system 301 may not even send an updated meeting invite 403 to user system 305 at step 5 but, rather, may simply update the entry in the user's calendar. User system 305 may then receive the update when the calendar synchronizes, when the user accesses their calendar, or calendar system 301 otherwise notifies user system 305 that the entry for meeting 402 has been updated.

After completion of operational scenario 500, the calendars for users of user systems 304-307 now include entries for meeting 402 that list the users of user systems 304-308 as being participants on meeting 402 whereas, prior to the completion, only the users of user systems 304-307 were listed as participants. While not shown, upon receiving meeting invite 403, user system 308 may also create an entry for meeting 402 in a calendar for its user that lists the users of user systems 304-308 as participants. User system 308 may create the entry locally, may create it a calendar maintained by calendar system 301 or 302, or may create the entry in some other calendar system. Likewise, in response to the user accepting meeting invite 403, user system 308 may transfer a meeting acceptance message to the organizer at user system 304, which may trigger steps similar to steps 3-7 to update the participants' calendar entries to indicate that the user of user system 308 has accepted meeting invite 403.

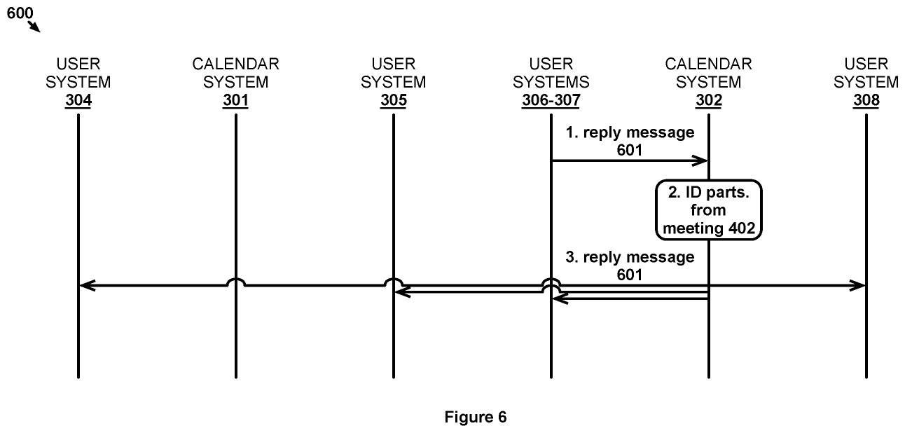

FIG. 6 illustrates operational scenario 600 for updating participants on a meeting invite across calendar systems. Operational scenario 600 is an example of an advantage of having all copies of the entries for meeting 402 list the users of user systems 304-308 as participants and, therefore, occurs after completion of operational scenario 500. In particular, to begin operational scenario 600 a user of user system 306 accesses the entry for meeting 402 in their calendar and types reply message 601. For instance, the user may want to notify other participants that the user will be late to meeting 402 and that the other participants should not wait to start. A user interface of calendar system 302 (or a locally executing application for interacting with calendar system 302) may supply an option for sending replies to participants on a meeting entry. Upon receiving reply message 601 from user system 306 at step 1, calendar system 302 determines the participants from the details of the entry for meeting 402 at step 2. In this case, since operational scenario 500 has already occurred, the participants are the users of user systems 304-308, as identified by their respective email addresses in the updated calendar entry for meeting 402. Had operational scenario 500 not been performed when meeting invite 403 was forwarded to user system 308, then the user of user system 308 would not be listed in the entry for meeting 402 in the calendar of the user of user system 306. Upon identifying the participants of meeting 402, calendar system 302 sends reply message 601 at step 3 to the email addresses of the other participants. In this example, those other participants receive reply message 601 at user systems 304-305 and 307-308. User system 306 does not receive a copy of reply message 601 in this example since reply message 601 originate from user system 306.

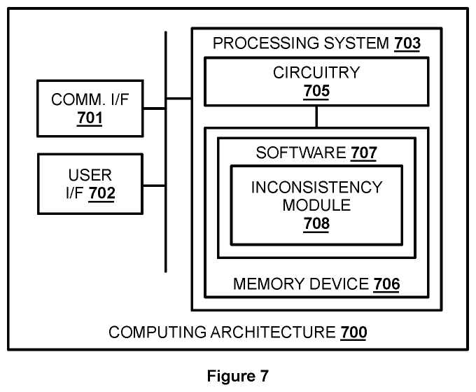

FIG. 7 illustrates computing architecture 700 for updating participants on a meeting invite across calendar systems. Computing architecture 700 is an example computing architecture for calendar systems 101-102 and 301-302, although systems 101-102 and 301-302 may use alternative configurations. Computing architecture 700 may also be used for other computing systems discussed herein, such as user systems, although those systems may also use alternative configurations. Computing architecture 700 comprises communication interface 701, user interface 702, and processing system 703. Processing system 703 is linked to communication interface 701 and user interface 702. Processing system 703 includes processing circuitry 705 and memory device 706 that stores operating software 707.

Communication interface 701 comprises components that communicate over communication links, such as network cards, ports, RF transceivers, processing circuitry and software, or some other communication devices. Communication interface 701 may be configured to communicate over metallic, wireless, or optical links. Communication interface 701 may be configured to use TDM, IP, Ethernet, optical networking, wireless protocols, communication signaling, or some other communication format—including combinations thereof.

User interface 702 comprises components that interact with a user. User interface 702 may include a keyboard, display screen, mouse, touch pad, or some other user input/output apparatus. User interface 702 may be omitted in some examples.

Processing circuitry 705 comprises microprocessor and other circuitry that retrieves and executes operating software 707 from memory device 706. Memory device 706 comprises a computer readable storage medium, such as a disk drive, flash drive, data storage circuitry, or some other memory apparatus. In no examples would a storage medium of memory device 706 be considered a propagated signal. Operating software 707 comprises computer programs, firmware, or some other form of machine-readable processing instructions. Operating software 707 includes update module 708. Operating software 707 may further include an operating system, utilities, drivers, network interfaces, applications, or some other type of software. When executed by processing circuitry 705, operating software 707 directs processing system 703 to operate computing architecture 700 as described herein.

In particular, update module 708 directs processing system 703 to receive a notification that a meeting invite for a meeting between a first participant and a second participant is forwarded to a third participant. A first calendar system implemented by processing system 703 maintains a first copy of the meeting invite on behalf of the first participant and a second calendar system maintains a second copy of the meeting invite on behalf of the second participant. In response to the notification, update module 708 directs processing system 703 to update the first copy to include the third participant and to direct the second calendar system to update the second copy to include the third participant.

The descriptions and figures included herein depict specific implementations of the claimed invention(s). For the purpose of teaching inventive principles, some conventional aspects have been simplified or omitted. In addition, some variations from these implementations may be appreciated that fall within the scope of the invention. It may also be appreciated that the features described above can be combined in various ways to form multiple implementations. As a result, the invention is not limited to the specific implementations described above, but only by the claims and their equivalents.

1. A method comprising:
in a first calendar system that maintains a first electronic calendar for a first participant accessible by a first user system of the first participant over a communication network using first protocols:
receiving a notification that a meeting invite for a meeting between the first participant and a second participant is forwarded to a third participant, wherein the first calendar system maintains a first copy of the meeting invite in the first electronic calendar on behalf of the first participant and a second calendar system maintains a second copy of the meeting invite in a second electronic calendar on behalf of the second participant, and wherein the second calendar system maintains the second electronic calendar for the second participant accessible by a second user system of the second participant over the communication network using second protocols different from the first protocols;
in response to the notification, updating the first copy to include the third participant; and
directing the second calendar system over the communication network using the second protocols to update the second copy to include the third participant.

2. The method of claim 1, wherein directing the second calendar system to update the second copy comprises:
sending an update message to the second calendar system, wherein the update message identifies the meeting invite and the third participant.

3. The method of claim 1, wherein directing the second calendar system to update the second copy comprises:
sending an updated version of the meeting invite to a user system of the second participant, wherein the updated version includes third participant and wherein the user system updates the second calendar system.

4. The method of claim 1, wherein the directing the second calendar system to update the second copy comprises:
directing the second calendar system to include an email address of the third participant on the second copy of the meeting invite with email addresses of the first and second participants.

5. The method of claim 1, wherein updating the first copy comprises:
including an email address of the third participant with email addresses of the first and second participants on the first copy.

6. The method of claim 1, wherein the notification comprises a forwarding notification indicating that the meeting invite has been emailed from the first participant to the third participant.

7. The method of claim 1, wherein the notification comprises an instruction from the first participant to include the third participant on the meeting invite.

8. The method of claim 1, wherein, before receiving the notification, the first calendar system maintains another copy of the meeting invite on behalf of a fourth participant on the meeting, and the method comprising:
in response to the notification, updating the other copy to include the third participant.

9. The method of claim 1, wherein, after the second copy is updated, further updates to the second copy by the second participant are propagated to the first participant and the third participant.

10. An apparatus comprising:
one or more computer readable storage media;
a processing system operatively coupled with the one or more computer readable storage media, wherein the processing system implements a first calendar system that maintains a first electronic calendar for a first participant accessible by a first user system of the first participant over a communication network using first protocols; and
program instructions stored on the one or more computer readable storage media that, when read and executed by the processing system, direct the processing system to:
receive a notification that a meeting invite for a meeting between the first participant and a second participant is forwarded to a third participant, wherein a first calendar system implemented by the processing system maintains a first copy of the meeting invite in the first electronic calendar on behalf of the first participant and a second calendar system maintains a second copy of the meeting invite in a second electronic calendar on behalf of the second participant and wherein the second calendar system maintains the second electronic calendar for the second participant accessible by a second user system of the second participant over the communication network using second protocols different from the first protocols;
in response to the notification, update the first copy to include the third participant; and
direct the second calendar system over the communication network using the second protocols to update the second copy to include the third participant.

11. The apparatus of claim 10, wherein to direct the second calendar system to update the second copy, the program instructions direct the processing system to:
send an update message to the second calendar system, wherein the update message identifies the meeting invite and the third participant.

12. The apparatus of claim 10, wherein to direct the second calendar system to update the second copy, the program instructions direct the processing system to:
send an updated version of the meeting invite to a user system of the second participant, wherein the updated version includes third participant and wherein the user system updates the second calendar system.

13. The apparatus of claim 10, wherein to direct the second calendar system to update the second copy, the program instructions direct the processing system to:
direct the second calendar system to include an email address of the third participant on the second copy of the meeting invite with email addresses of the first and second participants.

14. The apparatus of claim 10, wherein to update the first copy, the program instructions direct the processing system to:
include an email address of the third participant with email addresses of the first and second participants on the first copy.

15. The apparatus of claim 10, wherein the notification comprises a forwarding notification indicating that the meeting invite has been emailed from the first participant to the third participant.

16. The apparatus of claim 10, wherein the notification comprises an instruction from the first participant to include the third participant on the meeting invite.

17. The apparatus of claim 10, wherein, before receiving the notification, the first calendar system maintains another copy of the meeting invite on behalf of a fourth participant on the meeting, and the program instructions direct the processing system to:
in response to the notification, update the other copy to include the third participant.

18. The apparatus of claim 10, wherein, after the second copy is updated, further updates to the second copy by the second participant are propagated to the first participant and the third participant.

19. One or more computer readable storage media having program instructions stored thereon that, when read and executed by a processing system that implements a first calendar system that maintains a first electronic calendar for a first participant accessible by a first user system of the first participant over a communication network using first protocols, direct the processing system to:
receive a notification that a meeting invite for a meeting between the first participant and a second participant is forwarded to a third participant, wherein a first calendar system implemented by the processing system maintains a first copy of the meeting invite in the first electronic calendar on behalf of the first participant and a second calendar system maintains a second copy of the meeting invite in a second electronic calendar on behalf of the second participant, and wherein the second calendar system maintains the second electronic calendar for the second participant accessible by a second user system of the second participant over the communication network using second protocols different from the first protocols;
in response to the notification, update the first copy to include the third participant; and
direct the second calendar system over the communication network using the second protocols to update the second copy to include the third participant.

20. The one or more computer readable storage media of claim 19, wherein to direct the second calendar system to update the second copy, the program instructions direct the processing system to:
send an updated version of the meeting invite to a user system of the second participant, wherein the updated version includes third participant and wherein the user system updates the second calendar system.
